(19) United States
(12) Patent Application Publication
(10) Pub. No.: US 2006/0174484 A1
(43) Pub. Date: Aug. 10, 2006

(54) Heat pipe and manufacturing method thereof

(75) Inventors: Ming-Te Chuang, Taoyuan Hsien (TW); Chi-Feng Lin, Taoyuan Hsien (TW); Chin-Ming Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/395,183

(22) Filed: Apr. 3, 2006

Related U.S. Application Data
(63) Continuation-in-part of application No. 10/942,924, filed on Sep. 17, 2004.

(51) Int. Cl. B23P 6/00

(52) U.S. Cl. 29/890.032

(57) ABSTRACT

A heat pipe and manufacturing method thereof. The manufacturing method includes steps of: providing a pipe; shaping the pipe by bending or pressing according to requirements of a heat-dissipation module of an electronic device; inserting a molding bar into the pipe; forming a wick structure in the pipe; separating the molding bar from the pipe; and adding a working fluid to the pipe, wherein the working fluid is confined in a closed space of the pipe. The pipe is shaped before formation of the wick structure therein to prevent damage to the wick structure.

This application is a continuation-in-part application of U.S. patent application Ser. No. 10/942,924, filed on Sep. 17, 2004. The entire contents of the related application are incorporated herein by reference.

### BACKGROUND

The invention relates to a heat pipe, and in particular to a heat pipe and a manufacturing method thereof.

In the continued development of electronic devices, the number of transistors per unit area in an electronic device has increased to improve performance. As working efficiency is increased, frequent turning on or off of the transistors causes switch loss, increasing the temperature of the electronic device. In recent years, as development of semiconductors and IC design has improved, chip speed has substantially increased. Consequently, during operation of chips, heat energy is produced due to increases in clock frequency. Higher temperatures, however, lower chip speed such that performance deteriorates, and lifetime of the chip may be reduced accordingly.

External fans and heat-dissipation devices are normally installed in electronic devices to dissipate excess heat and maintain working temperature. Since heat dissipation of the electronic devices can increase effective chip speeds, fan speed is increased to accelerate heat conduction. However, power consumption and noise level both increase accordingly. As well, heat-dissipation devices such as heat-dissipation fins, while improving heat conduction, reduce the available internal space. Thus, currently, a heat pipe with a small cross section and low temperature differential is often used to provide a relatively long distance for heat conduction without requiring additional power supply. Further, compared to the heat-dissipation fins, the heat pipe occupies less internal space, and thus, is widely used in electronic devices.

FIG. 1 is a flowchart showing a conventional manufacturing method of a heat pipe. In step 102, a hollow copper pipe with a sealed end is provided. In step 104, a bar is inserted in the pipe. Since the pipe has a sealed end, normally being outwardly protruding and conical, an end of the bar can be disposed on the top of the conical sealed end. A gap is thus maintained between an inner wall of the pipe and the bar. The material of the bar is stainless steel, graphite, or other rigid materials.

In step 106, copper powder is filled in the gap between the inner wall of the pipe and the bar. Additionally, the copper powder can be further compressed and densely compacted according to the needs of manufacturers. In step 108, the copper powder is sintered to form a wick structure (or capillary structure) on the inner wall of the pipe. In step 110, the bar is pulled out from the pipe. In step 112, a working fluid is added, the pipe is vacuumed and the pipe opening is sealed. Depending on different wick structures, the steps of adding working fluid and vacuuming can be interchanged. In step 114, the completed cylindrical heat pipe is bent and pressed flat, with the final shape thereof depending on the requirements of subsequent heat-dissipation module design.

After manufacturing, however, in practice, the heat pipe, originally a straight cylindrical pipe, is reformed to become bent or flat. A portion of the wick structures in the pipe near the bent or areas is consequently impaired, losing heat conduction function, by as much as 70% or more.

### SUMMARY

Embodiments of the invention provide a manufacturing method for a heat pipe. The pipe is shaped before formation of the wick structure therein to prevent damage to the wick structure from subsequent process, thereby retaining heat conduction ability.

The heat pipe is applicable in a heat-dissipation module of an electronic device, being shaped according to requirements of the heat-dissipation module. The manufacturing method for a heat pipe includes steps of: providing a pipe; shaping the pipe by bending or pressing according to requirements of a heat-dissipation module of an electronic device; inserting a molding bar into the pipe; forming a wick structure in the pipe; separating the molding bar from the pipe; and adding a working fluid to the pipe, wherein the working fluid is confined in a closed space of the pipe.

The molding bar is inserted into the pipe, and then the pipe is shaped by bending or pressing according to requirements of the heat-dissipation module of an electronic device. Alternatively, the pipe is shaped by bending or pressing according to requirements of the heat-dissipation module of an electronic device, and then the molding bar is inserted into the pipe. Further, the wick structure is formed in the pipe before the molding bar is separated from the pipe. Alternatively, the molding bar is separated from the pipe before the wick structure is formed. A working fluid is added in the pipe and confined therein.

The pipe can be shaped by bending or pressing flat. Further, some protrusions are formed on a surface of the molding bar to maintain a gap between the inner wall of the pipe and the molding bar. The molding bar and the protrusions have the same material as that of the wick structure so that the molding bar and the protrusions become one part of the wick structure during formation. Alternatively, before separating the molding bar from the pipe, the protrusions are heated to vaporize or liquefy. The molding bar has flexible material such that the molding bar can be easily withdrawn from the pipe. The molding bar has a lower burning point than the wick structure so that the molding bar is separated from the pipe by being heated to vaporize or liquefy. Alternatively, the molding bar, soluble in an organic solvent, can include organically soluble material such as an organic polymer, soluble in an appropriate solvent such as acetone, so that the molding bar is separated from the pipe by being dissolved in the organic solvent.

### BRIEF DESCRIPTION OF THE DRAWINGS

The invention can be more fully understood by reading the subsequent detailed description in conjunction with the examples and references made to the accompanying drawings, wherein:

FIG. 1 is a flowchart showing a conventional manufacturing method of a heat pipe;

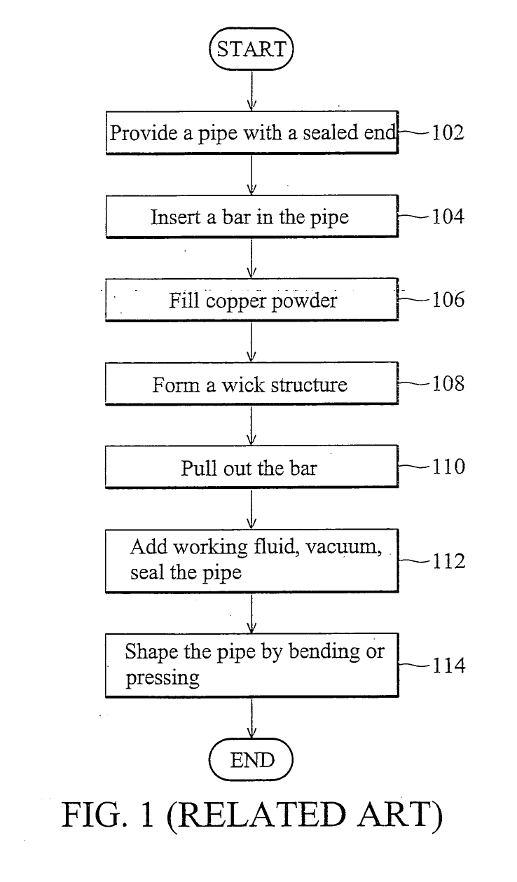

FIG. 2 is a flowchart showing a manufacturing method of a heat pipe according to a first embodiment of the invention; and

FIG. 3 is a flowchart showing a manufacturing method of a heat pipe according to a second embodiment of the invention.

### DETAILED DESCRIPTION

### First Embodiment

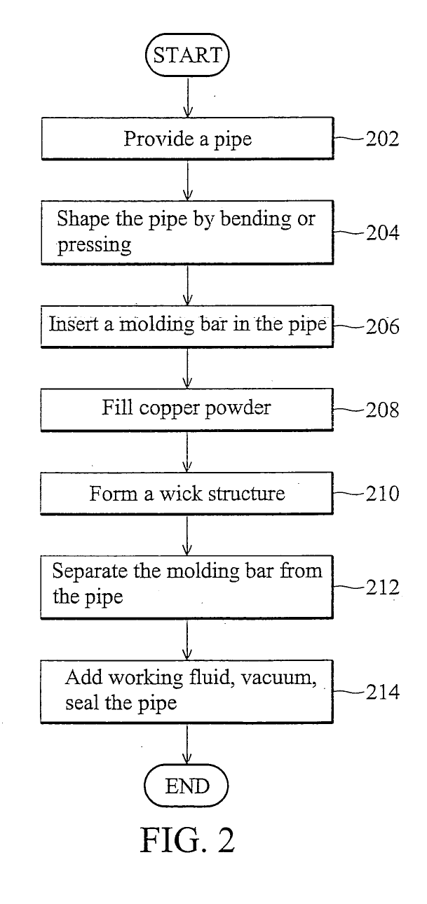

FIG. 2 is a flowchart showing a manufacturing method of a heat pipe of a first embodiment of the invention, in which, in step 202, a pipe is provided, and the material of the pipe includes plastic, metal, alloy, or non-metal materials. In this case, a copper pipe is provided as an example. In step 204, the pipe is shaped according to the subsequent manufacturing requirements of a heat-dissipation module of an electronic device. The pipe can be shaped by bending or pressing.

In step 206, a molding bar is inserted in the pipe with a gap maintained between the inner wall of the pipe and the molding bar. It is noted that step 206 can be performed before step 204 or after step 204. Specifically, when the step 206 is performed before step 204, the molding bar is inserted in the pipe and then the pipe and the molding bar are shaped together by bending or pressing according to requirements of the heat-dissipation module of an electronic device. The molding bar is a flexible material allowing easy withdrawal from the bent or pipe. A plurality of identical-sized protrusions, formed on the surface of the molding bar, allow not only the gap between the inner wall of the pipe and the molding bar to be maintained, but also maintain constant gap size throughout the pipe.

In step 208, copper powder is filled in the gap between the inner wall of the pipe and the molding bar. In step 210, a wick structure is formed therein. The wick structure is preferably a mesh wick, fiber wick, sinter wick, or grooved wick, formed by sintering, gluing, filling, depositing, and so on. In this embodiment, the copper pipe is used, and thus, copper powder or other metal alloy powder is filled in the gap between the inner wall of the pipe and the molding bar before sintering to form the wick structure. The copper powder can be further compressed and become densely compacted before sintering so that the wick structure of varying porosity or structure is formed. Also, different filling materials may require corresponding solvent or chelating agents to increase density of the copper powder, whereby, before sintering, drying or removal of solvent or chelating agents may be required to remove the solvent or chelating agents.

In step 212, the molding bar is separated from the pipe, and in step 214, working fluid is added and vacuum is then performed. The pipe is sealed and working fluid is confined and flows in a closed space of the sealed pipe. The working fluid can include inorganic compounds, water, alcohol, liquid metal such as mercury, ketone, chlorofluorocarbons (CFCs) such as HFC-134a, or other organic compounds. Generally, the most frequently used working fluid is water. Because the surface tension between corresponding fluids differs with wick structures, the sequence of adding the working fluid and vacuuming can be interchanged, followed by sealing the pipe.

### Second Embodiment

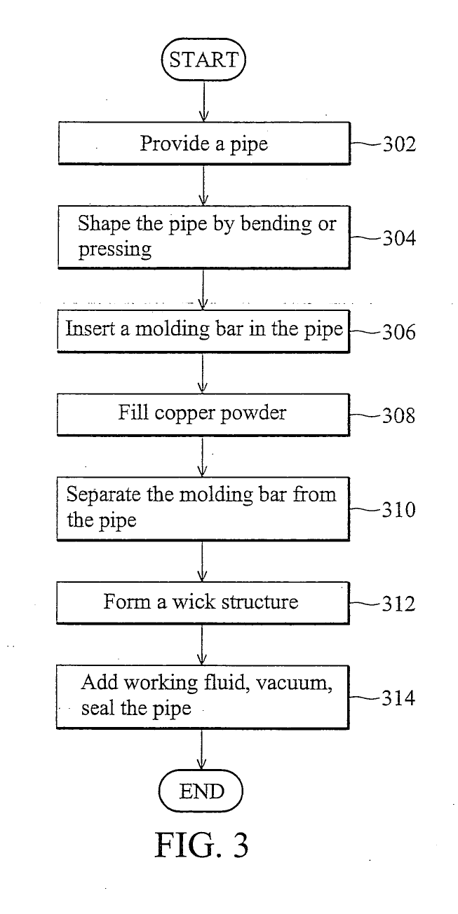

FIG. 3 is a flowchart showing a manufacturing method of a heat pipe of a second embodiment of the invention. The steps of the second embodiment are similar to those of the first embodiment. In step 302, a pipe is provided, preferably a copper pipe. In step 304, the pipe is shaped according to the subsequent manufacturing requirements of a heat-dissipation module of an electronic device. The pipe can be shaped by bending or pressing.

In step 306, a molding bar is inserted in the pipe with a gap maintained between the inner wall of the pipe and the molding bar. It is noted that step 306 can be performed before step 304 or after step 304. Specifically, when the step 306 is performed before step 304, the molding bar is inserted in the pipe and then the pipe and the molding bar are shaped together by bending or pressing according to requirements of the heat-dissipation module of an electronic device. In step 308, copper powder is filled in the gap between the inner wall of the pipe and the molding bar. Additionally, according to the size of copper powder grains and porosity of wick structure, other manufacturing steps are implemented. For example, after filling the copper powder, the copper powder is compressed. Different filling materials may require corresponding solvent or chelating agents to increase density of the copper powder, whereby before forming the wick structure, drying or removal of solvent or chelating agents may be required to remove the solvent or chelating agents.

Furthermore, in step 310, the molding bar is separated from the pipe. In step 312, a wick structure is formed. The wick structure is preferably a mesh wick, fiber wick, sinter wick, grooved wick, formed by sintering, gluing, filling, or depositing, and so on. Lastly, in step 314, working fluid is added therein and followed by vacuuming. The opening of the pipe is sealed to complete production of the heat pipe. Because the surface tension between fluids differs with wick structures, the sequence of adding the working fluid and vacuuming can be interchanged, followed by sealing the pipe.

In the second embodiment, the molding bar is separated from the pipe before forming the wick structure, and the steps can be interchanged depending on different manufacturing requirements. The molding bar is flexible with a plurality of protrusions formed on a surface thereof. Furthermore, the molding bar may have a lower burning point than the wick structure, so that the molding bar is separated from the pipe by being heated to vaporize or liquefy when the wick structure is formed in the pipe. Alternatively, the molding bar may include a material soluble in organic solvents, such as an organic polymer.

Since the molding bar includes a flexible material, the molding bar can be easily withdrawn from the pipe. Furthermore, because a plurality of protrusions on the molding bar are the same material as that of the wick structure, the protrusions are sintered and become one part of the wick structure during formation of the wick structure. The protrusions may also have a lower burning point than the wick structure, such that during sintering the protrusions are vaporized or liquefied.

If the molding bar includes a material soluble in an organic solvent, the molding bar is dissolved by the organic solvent. For example, while the organic solvent is an organic polymer, the solvent is acetone.

In conclusion, in embodiments of the invention, the pipe is shaped before forming the wick structure in the pipe. Since after formation of the wick structure there is no subsequent process of the pipe, the wick structure can be preserved. Thus, the heat conduction ability is increased. Furthermore, the heat pipe produced by the manufacturing method is applicable in any heat-dissipation module of electronic devices. The pipe can be initially shaped according to requirements of different heat-dissipation modules so that the contact area between the heat pipe and a surface of an electronic device is maximized to increase heat dissipation.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A manufacturing method for a heat pipe, comprising steps of:
providing a pipe;
shaping the pipe by bending or pressing according to requirements of a heat-dissipation module of an electronic device;
inserting a molding bar into the pipe;
forming a wick structure in the pipe;
separating the molding bar from the pipe; and
adding a working fluid to the pipe, wherein the working fluid is confined in a closed space of the pipe.

2. The method as claimed in claim 1, wherein the molding bar comprises a plurality of protrusions, formed on a surface of the molding bar, to maintain a gap between an inner wall of the pipe and the molding bar.

3. The method as claimed in claim 2, wherein the protrusions has the same material as that of the wick structure so that the protrusions become one part of the wick structure during formation.

4. The method as claimed in claim 2, wherein before separating the molding bar from the pipe, the protrusions are heated to vaporize or liquefy.

5. The method as claimed in claim 1, wherein the molding bar comprises flexible materials such that the molding bar can be withdrawn from the pipe.

6. The method as claimed in claim 1, wherein the molding bar has a lower burning point than the wick structure so that the molding bar is separated from the pipe by being heated to vaporize or liquefy.

7. The method as claimed in claim 1, wherein the molding bar is soluble in an organic solvent so that the molding bar is separated from the pipe by being dissolved in the organic solvent.

8. The method as claimed in claim 7, wherein the molding bar comprises an organic polymer and the organic solvent comprises acetone.
